(19) United States
(12) Patent Application Publication
(10) Pub. No.: US 2021/0086990 A1
(43) Pub. Date: Mar. 25, 2021

(54) SYSTEM AND METHOD FOR MANAGING TRASH

(71) Applicant: Oladayo Luke, Severn, MD (US)

(72) Inventor: Oladayo Luke, Severn, MD (US)

(21) Appl. No.: 16/578,348

(22) Filed: Sep. 22, 2019

(51) Int. Cl. B65F 1/14; G06N 20/00; B65F 1/00; B65F 1/12

(52) U.S. Cl. CPC B65F 1/1426; G06N 20/00; B65F 1/1473; B65F 1/12; B65F 1/1421; B65F 1/004

(57) ABSTRACT

Disclosed is a trash management system comprising at least one container, the at least one container when in operation is operable to manage trash, the system comprising: an imaging arrangement to capture one or more images of an environment of the at least one container; a database arrangement coupled to the imaging arrangement, wherein the database arrangement is configured to store the one or more images; and a first data processing arrangement coupled to the imaging arrangement and the database arrangement, wherein the first data processing arrangement is configured to: receive the trash in one or more sub-chambers inside the at least one container, at a first location; move the at least one container from the first location to a second location based on a set of instructions, wherein the second location is a trash storage site; transfer the trash from the at least one container to the trash storage site; and move the at least one container from the second location to the first location.

### TECHNICAL FIELD

The present disclosure relates generally to disposing of trash; and more specifically, to trash management systems. Moreover, the present disclosure also relates to methods implemented by trash management systems.

### BACKGROUND

With developments in human society and lifestyle, collection and disposal of trash has become essential. Trash is collected for the homes in trash cans. Generally, people move trash cans used for collecting trash at homes, from backyard of their home or outside of their home, to community trash service pickup truck to pick it up. The trash service pickup is scheduled once or twice a week depending on a size of a community. Moreover, they make two trips to pickup different types of trash.

However, many people forget to move trash to outside for trash service pickup at a regular time interval. Moreover, when people do not take out trash to a front of their home and by a road for trash service pickup truck to access, the trash will remain at the house until the next day. Moreover, some disabled and senior people find it challenging to meet trash service pickup truck requirement and as a result, will require a third party help to move the trash.

Therefore, in the light of foregoing discussion, there exists a need to overcome the aforementioned drawbacks associated with trash management.

### SUMMARY

The present disclosure seeks to provide a trash management system. The present disclosure also seeks to provide a method implemented by a trash management system. The present disclosure seeks to provide a solution to the existing problem of timely trash disposal. An aim of the present disclosure is to provide a solution that overcomes at least partially the problems encountered in prior art, and provides a technique to collect trash and dispose trash timely and efficiently.

In one aspect, an embodiment of the present disclosure provides a trash management system comprising an at least one container, the at least one container when in operation is operable to manage trash, the system comprising:
an imaging arrangement to capture one or more images of an environment of the at least one container;
a database arrangement coupled to the imaging arrangement, wherein the database arrangement is configured to store the one or more images and a set of instructions; and
a first data processing arrangement coupled to the imaging arrangement and the database arrangement, wherein the first data processing arrangement is configured to:
   receive the trash in one or more sub-chambers inside the at least one container, at a first location;
   move the at least one container from the first location to a second location, wherein the second location is a trash storage site, based on the one or more images of the environment captured by the imaging arrangement and the set of instructions;
   transfer the trash from the at least one container to the trash storage site; and
   move the at least one container from the second location to the first location, based on the one or more images of the environment captured by the imaging arrangement and the set of instructions.

In another aspect, an embodiment of the present disclosure provides a method implemented by a trash management system comprising an at least one container, the at least one container when in operation is operable to manage trash, the method comprises:
capturing one or more images of an environment of the at least one container;
receiving the trash inside the at least one container, at a first location;
moving the at least one container from the first location to a second location, wherein the second location is a trash storage site, based on the one or more images of the environment and a set of instructions;
transferring the trash from the at least one container to the trash storage site; and
moving the at least one container from the second location to the first location, based on the one or more images of the environment and the set of instructions.

Embodiments of the present disclosure substantially eliminate or at least partially address the aforementioned problems in the prior art, and enables efficient collection and disposal of trash.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a trash management system, in accordance with an embodiment of the present disclosure;

FIG. 2 is an exemplary container operable to manage trash in the trash management system, in accordance with an embodiment of the present disclosure;

FIG. 3 is an exemplary autonomous device operable to enable movement of at least one container, in accordance with an embodiment of the present disclosure;

FIG. 4 is an exemplary implementation of the trash management system, in accordance with an embodiment of the present disclosure;

FIGS. 5A and 5B are exemplary autonomous device to enable movement of the at least one container, in accordance with different embodiments of the present disclosure; and

FIG. 6 is steps of a method implemented by a trash management system, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a trash management system comprising an at least one container, the at least one container when in operation is operable to manage trash, the system comprising:
an imaging arrangement to capture one or more images of an environment of the at least one container;
a database arrangement coupled to the imaging arrangement, wherein the database arrangement is configured to store the one or more images and a set of instructions; and
a first data processing arrangement coupled to the imaging arrangement and the database arrangement, wherein the first data processing arrangement is configured to:
   receive the trash in one or more sub-chambers inside the at least one container, at a first location;
   move the at least one container from the first location to a second location, wherein the second location is a trash storage site, based on the one or more images of the environment captured by the imaging arrangement and the set of instructions;
   transfer the trash from the at least one container to the trash storage site; and
   move the at least one container from the second location to the first location, based on the one or more images of the iso environment captured by the imaging arrangement and the set of instructions.

In another aspect, an embodiment of the present disclosure provides a method implemented by a trash management system comprising an at least one container, the at least one container when in operation is operable to manage trash, the method comprises:
capturing one or more images of an environment of the at least one container;
receiving the trash inside the at least one container, at a first location;
moving the at least one container from the first location to a second location, wherein the second location is a trash storage site, based on the one or more images of the environment and a set of instructions;
transferring the trash from the at least one container to the trash storage site; and
moving the at least one container from the second location to the first location, based on the one or more images of the environment and the set of instructions.

The present disclosure provides techniques for efficient trash management. The present disclosure provides a trash management system which is operable to collect trash in an at least one container at a generation source, timely move the at least one container to a trash disposal site, transfer the trash to the trash disposal site and move the at least one container back to the generation source. The trash management system is operable to perform all the functions automatically with the help of machine learning algorithms. The at least one container can be easily navigated and controlled by a user. Moreover, the trash management system is anti-theft.

The present disclosure provides the trash management system comprising the at least one container, the at least one container when in operation is operable to manage trash. The system is a collection of one or more interconnected programmable and/or non-programmable components configured to receive, transfer and manager trash. Examples include programmable and/or non-programmable components, such as processors, memories, connectors, cables and the like. Moreover, the programmable components are configured to store and execute one or more computer instructions. It will be appreciated that trash is stored temporarily in the at least one container and upon completion of certain activities such as complete filling of the at least one container with the trash, the trash is transferred from the at least one container to the trash storage site such as a trash dumping site. In an example, in a day-to-day household environment a user dumps their trash into the at least one container. Moreover, in such a case, the at least one container is further operable to transfer the trash from the household environment to a trash dumping environment. The management of the trash is essential to enable a continuous cycle of collection and transferring of the trash to trash dumping site. The term “at least one container” as used herein refers to a vessel which is intended to receive and hold the trash generated by a given user. Optionally, the at least one container is operable to receive trash of different materials. The term “trash” as used herein refers to an entity which cannot be utilized by the user and thereby is a waste product for the user. Examples of trash include but are not limited to vegetable waste, cans, clothing, food packaging, newspapers, magazines, faulty electronic items and the like.

Moreover, the system comprises the imaging arrangement to capture one or more images of the environment of the at least one container.

Throughout the present disclosure, the term “imaging arrangement” refers to an equipment that is operable to detect and process light from the environment around the at least one container, so as to capture one or more images of the environment. Specifically, the imaging arrangement is a image capturing device such as a camera. The imaging arrangement comprises one or more cameras wherein each camera is operable to capture different images of the environment of the at least one container. Optionally, position of each camera in the imaging arrangement is fixed. Alternatively optionally, position of each camera in the imaging arrangement is moving with respect to the at least one container. Optionally, a first camera of the imaging arrangement is positioned at a first end of the at least one container and a second camera of the imaging arrangement is positioned at a second end of the at least one container. The term “environment” as used herein refers to a surrounding of the at least one container which is intended to change based on a movement of the at least one container. Moreover, the one or more images of the environment enable the at least one container to follow a defined path by avoiding obstacles.

Furthermore, the database arrangement is coupled to the imaging arrangement. The database arrangement is configured to store the one or more images and the set of instructions. Throughout the present disclosure, the term “database arrangement” as used herein relates to an organized body of digital information regardless of the manner in which the information or the organized body thereof is represented. Optionally, the database arrangement may be hardware, software, firmware and/or any combination thereof. For example, the organized body of related data may be in the form of a table, a map, a grid, a packet, a datagram, a file, a document, a list or in any other form. The database arrangement includes any data storage software and systems, such as, for example, a relational database like IBM DB2 and Oracle 9. Furthermore, the database arrangement refers to a software program for creating and managing one or more databases. Optionally, the database arrangement may be operable to support relational operations, regardless of whether it enforces strict adherence to the relational model, as understood by those of ordinary skill in the art. The database arrangement is coupled to the imaging arrangement via wired connections or wireless connections or a combination thereof. The term “set of instructions” refers to one or more commands that are pre-stored or provided by an external device for controlling functions of the at least one container.

In an embodiment, the system further comprises a user device coupled to the first data processing arrangement wherein the user device is operable to provide the set of instructions to the first data processing arrangement. Throughout the present disclosure, the term “user device” relates to an electronic device associated with (or used by) a user that is capable of enabling the user to perform specific tasks associated with the aforementioned system. Furthermore, the user device is intended to be broadly interpreted to include any electronic device that may be used for voice and/or data communication over a wireless communication network. Examples of user device includes, but are not limited to, cellular phones, personal digital assistants (PDAs), handheld devices, wireless modems, laptop computers, personal computers, and the like. Additionally, the user device includes a casing, a memory, a processor, a network interface card, a microphone, a speaker, a keypad, and a display. Moreover, the user device is to be construed broadly, so as to encompass a variety of different types of mobile stations, subscriber stations or, more generally, communication devices, including examples such as a combination of a data card inserted in a laptop. Optionally, the user device is a remote controller for controlling the at least one container. The term ‘user’ as used herein relates to any entity including a person (i.e., human being) or a virtual personal assistant (an autonomous program or a bot) using the user device and/or system described herein.

Furthermore, the system comprises the first data processing arrangement coupled to the imaging arrangement and the database arrangement. Throughout the present disclosure, the term “first data processing arrangement” as used herein refers to programmable and/or non-programmable components configured to execute one or more software application for storing, processing and/or share data and/or set of instruction. Optionally, the first data processing arrangement can include, for example, a component included within an electronic communications network. Additionally, the first data processing arrangement include one or more data processing facilities for storing, processing and/or share data and/or set of instruction. Furthermore, the first data processing arrangement includes hardware, software, firmware or a combination of these, suitable for storing and processing various information and services accessed by the one or more user using the one or more user devices. Optionally, the first data processing arrangement include functional components, for example, a processor, a memory, a network adapter and so forth. The first data processing arrangement is coupled to the imaging arrangement and the database arrangement via wired connections or wireless connections or a combination thereof.

Moreover, the first data processing arrangement is configured to receive the trash in one or more sub-chambers inside the at least one container, at the first location. It will be appreciated that the at least one container is configured to have one or more sub-chambers to receive trash of different materials in each of the sub-chambers. Optionally, at least one container is configured to have one or more sub-chambers to receive trash from different users. In an example, a user is operable to put the trash generated by them in the at least one container at a particular time such as 8 a.m. or at regular time intervals. The term “first location” refers to a place and/or a position of the at least one container where the at least one container is positioned to receive the trash from the user. In an example, the first location is a house of the user.

In an embodiment, the system further comprises a sensory circuitry to sense a level of trash inside the at least one container. Throughout the present disclosure, the term “sensor circuitry” as used herein relates to a system or assembly that contains sensors and if necessary any other peripheral devices or components required for operation of the sensors, and transmittance or communication of the sensor data. Furthermore, sensor is a device that detects (and possibly responds to) signals, stimuli or changes in quantitative and/or qualitative features of the given system, or the environment in general, and provides a corresponding output. The output is generally a signal that can be converted to human-readable display at the sensor location or transmitted electronically over a network for reading or further processing to the user device. Additionally, the sensor circuitry includes any device which can provide a form of perceived perceptual information. Optionally, the sensory circuitry is an infrared based sensory circuitry. The sensory circuitry is connected to the first data processing arrangement to enable computation of the level of the trash inside the at least one container by the first data processing arrangement. Moreover, based on the computation by the first data processing arrangement, it is operable to stop the at least one container from receiving more trash if a highest level of trash intended to be accommodated in the at least one container is achieved.

Furthermore, the first data processing arrangement is configured to move the at least one container from the first location to the second location based on the one or more images of the environment captured by the imaging arrangement and the set of instructions stored in the database arrangement. Moreover, the second location is the trash storage site. In an example, the at least one container is moved if a highest level of trash inside the at least one container is achieved. In another example, the at least one container is moved if a time allotted for collection of trash in the trash storage site is achieved. In an example, a time of 10 a.m. is allotted for collection of trash in the trash storage site, thereby the at least one container is operable to move to the second location and reach the second location at 10 a.m. to deliver the trash. The set of instructions provide a pathway to the at least one container for moving to the second location. Optionally, a given user is operable to provide the pathway to the at least one container via the user device. More optionally, a given user is operable to control the movement of the at least one container via a remote controller to move the at least one container to the second location. The at least one container is operable to move from the first location to the second location based on one or more images captured by the imaging arrangement in real-time or near real-time.

In an embodiment, the system further comprises a navigation module to enable the user device to track the at least one container. In an example, the navigation module is a global positioning satellite (gps) module. The navigation module enables the user device to locate the at least one container. The user device may track at a position of the at least one container in the path between the first location and the second location.

In an embodiment, the system further comprises a first set of motor arrangement to move the at least one container. Optionally, the first set of motor arrangement is coupled to wheels which are attached to the at least one container to enable movement of the at least one container. In an example, the at least one container comprises two wheels at a front end and two wheels at a second end. In such an example, the first set of motor arrangement is used to enable movement of the four wheels. The first set of motor arrangement is powered by a power storage battery coupled to the first set of motor arrangement via the first data processing arrangement.

Moreover, the first data processing arrangement is configured to transfer the trash from the at least one container to the trash storage site. It will be appreciated that the at least one container is operable to transfer the trash by tilting the at least one container. Optionally, the at least one container comprises a plate at a bottom of the at least one container, the plate is operable to move from the bottom of the at least one container to a top of the at least one container and thereby push the trash out of the at least one container to the trash storage site. Moreover, upon the transfer of the trash from the at least one container to the trash storage site, the at least one container is available to receive trash.

In an embodiment, the system further comprises a second set of motor arrangement to transfer the trash from the at least one container. Optionally, the second set of motor arrangement is operable to tilt the at least one container to transfer the trash. More optionally, the second set of motor arrangement is coupled to the aforesaid plate to enable pushing of the trash from the at least one container.

The first data processing arrangement is configured to move the at least one container from the second location to the first location, based on the one or more images of the environment captured by the imaging arrangement and the set of instructions stored in the database arrangement. In an example, the at least one container is moved if a level of trash inside the at least one container is zero. In another example, the at least one container is moved if a time allotted for collection of trash in the trash storage site has ended. In an example, a time of 10 a.m. to 10:05 a.m. is allotted for collection of trash in the trash storage site, thereby the at least one container is operable to move to the first location after the time allotted such as 10:05 a.m. has ended. The set of instructions provide a pathway to the at least one container for moving back to the first location. Optionally, the set of instructions provided for a pathway to the second location from the first location is used for moving the at least one container back to the first location. Optionally, a given user is operable to provide the pathway to the at least one container via the user device. More optionally, a given user is operable to control the movement of the at least one container via a remote controller to move the at least one container to the first location. The at least one container is operable to move from the second location to the first location based on one or more images captured by the imaging arrangement in real-time or near real-time.

In an embodiment, the first data processing arrangement is implemented by a machine learning based circuitry. Throughout the present disclosure, the term “machine learning based circuitry” as used herein relates to any mechanism or computationally intelligent system that combines knowledge, techniques, and methodologies for controlling a bot or other element within a computing environment. Furthermore, the machine learning based circuitry is configured to apply knowledge and that can adapt it-self and learn to do better in changing environments. Additionally, employing any computationally intelligent technique, the machine learning based circuitry is operable to adapt to unknown or changing environment for better performance. The machine learning based circuitry includes fuzzy logic engines, decision-making engines, preset targeting accuracy levels, and/or programmatically intelligent software. Optionally, the machine learning based circuitry is operable to perform all the aforesaid operations done by the user via a user device.

Optionally, the machine learning based circuitry in the context of the present disclosure relates to software-based algorithms that are executable upon computing hardware such as first data processing arrangement and are operable to adapt and adjust their operating parameters in an adaptive manner depending upon information that is presented to the software-based algorithms when executed upon the computing hardware. Optionally, the machine learning based circuitry includes neural networks such as recurrent neural networks, recursive neural networks, feed-forward neural networks, convolutional neural networks, deep belief networks, and convolutional deep belief networks; self-organizing maps; deep Boltzmann machines; and stacked de-noising auto-encoders.

Optionally, the machine learning based circuitry employ any one or combination of the following computational techniques: constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing.

In an embodiment, the machine learning based circuitry is trained based on the set of instructions provided by the user device. Optionally, at an initial phase the functionality and operations of the system are controlled by the user via the user device. Moreover, upon receiving the set of instructions from the user device for a threshold number of times the machine learning based circuitry is operable to control the functionality and operations of the system by training on the set of instructions from the user at the initial phase.

Optionally, the system is powered by a power source such as a direct current (D.C.) battery. Moreover, upon consumption of the power source, the system is operable to enable the at least one container to move to a charging station to charge the power source.

Optionally, the system is operable to enable the at least one container to detect and avoid obstacles in the pathway between the first location and the second location.

Optionally, the system is operable to send to the user device continuous updates related to the trash management system via one or more notifications.

Optionally, the system is anti-theft. More optionally, the system is operable to send a notification to the user device upon detection of theft. More optionally, the system is operable to send a location of the at least one container when detection of theft.

In an exemplary implementation, wherein a user is unable to take the at least one container from the first location to the second location to transfer the trash, in such a case, the system enables the at least one container to conduct the aforesaid operations automatically without user intervention.

In an embodiment, the system further comprises an autonomous device coupled to the at least one container to enable movement of the at least one container from the first location to the second location and from the second location to the first location. The term “autonomous device” as used herein refers to a vehicle capable of carrying and moving the at least one container via plurality of wheels present on the autonomous device. Optionally, the autonomous device is pre-programmed with instructions for controlling the movement of the at least one container.

In an embodiment, the autonomous device is coupled to a first container of the at least one container by placing the first container on the autonomous device and/or is coupled at most two containers via a connecting rod. Optionally, the autonomous device may drag the at most two containers coupled via the connecting rod. In an example, the autonomous device may be coupled to a first container, a second container and a third container. In such an example, the autonomous device may carry the first container and drag the second container and the third container. Optionally, the connecting rod is adjustable in size and thereby the size of the connecting rod may be varied to enable proper movement of the at least one container

In an embodiment, the connecting rod comprises one or more gripping arrangements to enable coupling of autonomous device to the at most two container. Optionally, the one or more gripping arrangements are connected to the connecting rod to enable a flexible connection between the connection rod and the at most two containers.

In an embodiment, the autonomous device further comprises a second data processing arrangement coupled to the first data processing arrangement to enable controlling the movement of the at least one container. Optionally, the second data processing arrangement may receive instructions for controlling the movement of the at least one container from the first data processing arrangement. In an embodiment, the second data processing arrangement is configured to do the similar operations as the first data processing arrangement.

The present disclosure also relates to the method as described above. Various embodiments and variants disclosed above apply mutatis mutandis to the method.

Optionally, the method further comprises receiving the set of instructions from a user device.

Optionally, the method is implemented by a machine learning based circuitry.

Optionally, the machine learning based circuitry is trained based on the set of instructions provided by the user device.

Optionally, the method further comprises sensing a level of trash inside the at least one container.

### DETAILED DESCRIPTION OF THE DRAWINGS

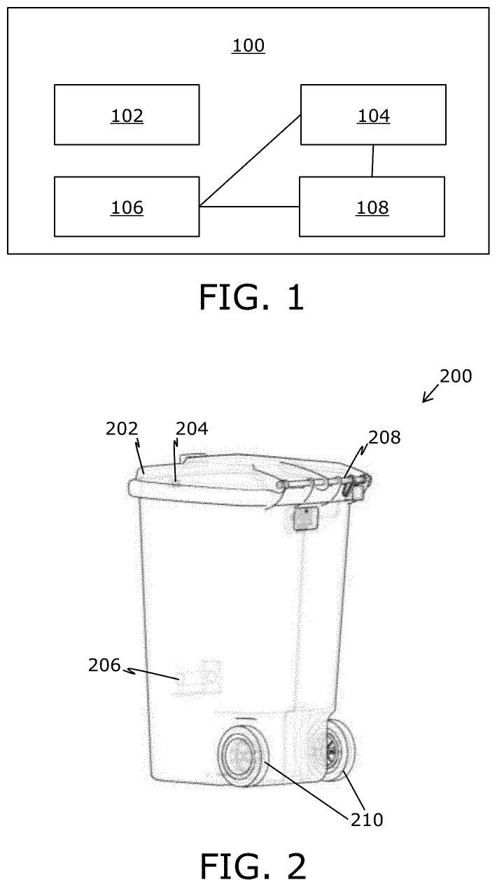

Referring to FIG. 1, illustrated is a block diagram of a trash management system 100, in accordance with an embodiment of the present disclosure. The system 100 comprises a at least one container 102. As shown, the system comprises an imaging arrangement 104, a database arrangement 106, a first data processing arrangement 108.

The database arrangement 106 is coupled to the imaging arrangement 104. The first data processing arrangement 108 coupled to the imaging arrangement 104 and the database arrangement 106.

Referring to FIG. 2, illustrated is an exemplary container 200 operable m to manage trash in a trash management system, in accordance with an embodiment of the present disclosure. The container 200 comprises a cover 202, a motion sensor 204, a lifting handle 206, connecting rod 208 and wheels 210.

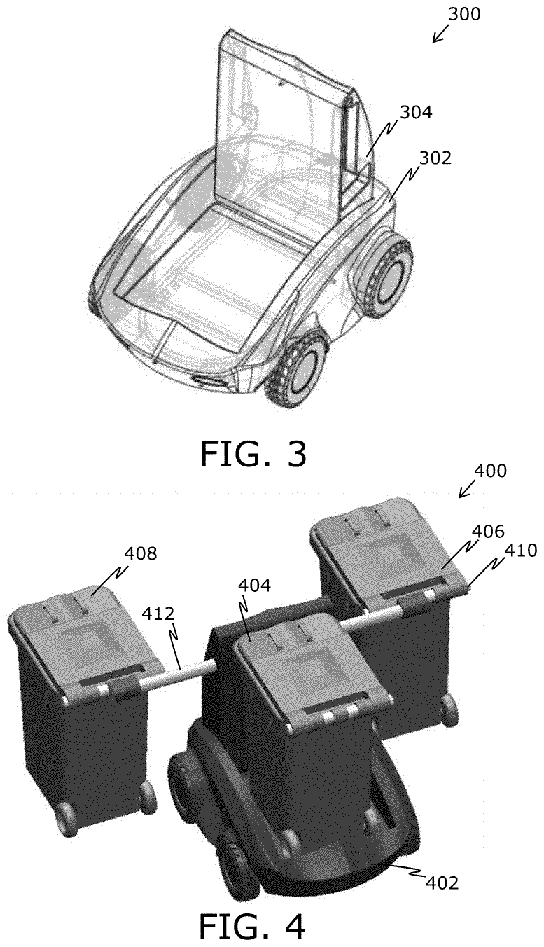

Referring to FIG. 3, illustrated is an exemplary autonomous device 300 to enable movement of the at least one container (not shown), in accordance with an embodiment of the present disclosure. The autonomous device 300 comprises robot body 302 and robot arm 304.

Referring to FIG. 4, illustrated is an exemplary implementation of trash management system 400, in accordance with an embodiment of the present disclosure. The trash management system 400 comprises an autonomous device 402. The autonomous device 402 is coupled to a first container 404 by placing the first container 404 on the autonomous device 402. Moreover, the autonomous device 402 is coupled to two containers depicted as 406 and 408 via a connecting rod depicted as 410 and 412 respectively.

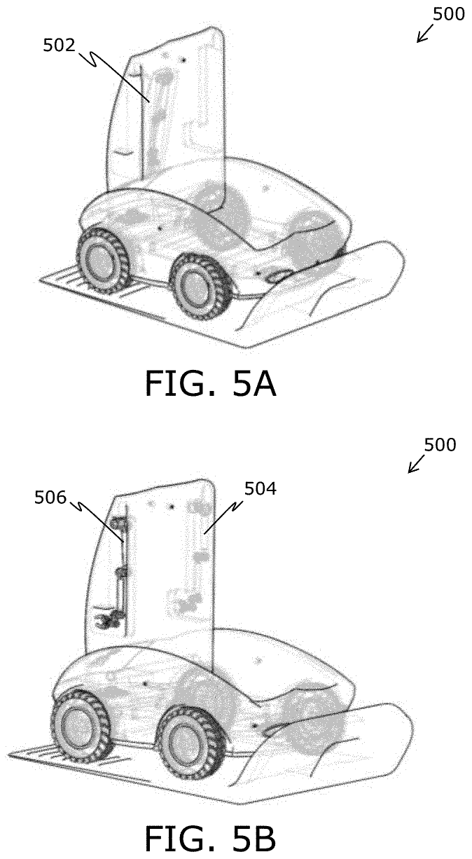

Referring to FIGS. 5A and 5B, illustrated are exemplary autonomous devices 500 to enable movement of the at least one container (not shown), in accordance with an embodiment of the present disclosure.

Referring to FIG. 5A, the autonomous device 500 comprises one robotic arm 502 for coupling to a container (not shown).

Referring to FIG. 5B, the autonomous device 500 comprises two robotic arm depicted as robotic arms 504 and 506 for coupling to two container (not shown).

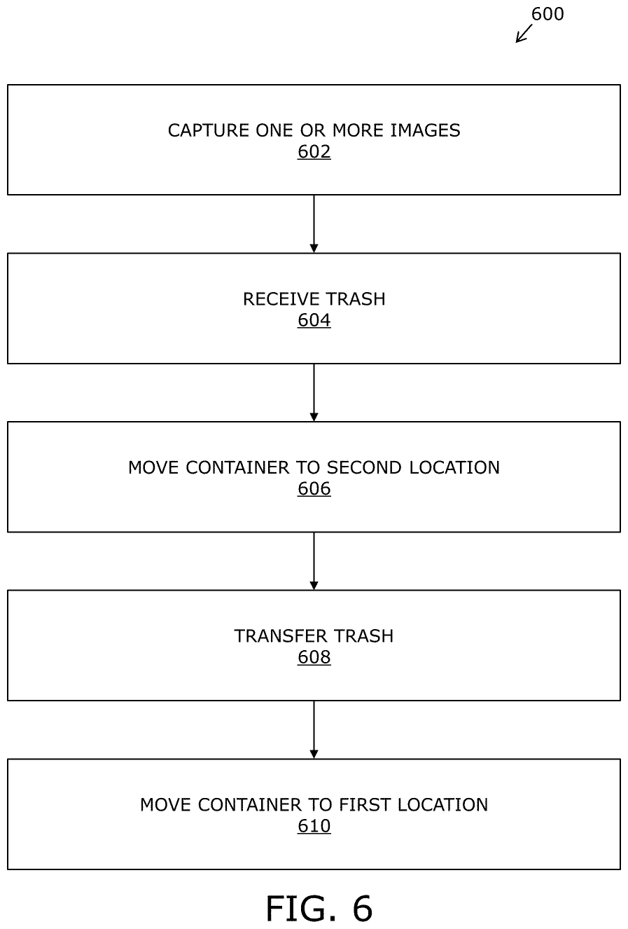

Referring to FIG. 6, illustrated is steps of a method 600 implemented by a trash management system, in accordance with an embodiment of the present disclosure. The trash management system comprising an at least one container, the at least one container when in operation is operable to manage trash. At a step 602, one or more images of an environment of the at least one container is captured. At a step 604, the trash inside the at least one container is received at a first location. At a step 606, the at least one container is moved from the first location to a second location, based on the one or more images of the environment and a set of instructions, wherein the second location is a trash storage site. At a step 608, the trash is transferred from the at least one container to the trash storage site. At a step 610, the at least one container is moved from the second location to the first location, based on the one or more images of the environment and the set of instructions.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A trash management system comprising an at least one container, the at least one container when in operation is operable to manage trash, the system comprising:
an imaging arrangement to capture one or more images of an environment of the at least one container;
a database arrangement coupled to the imaging arrangement, wherein the database arrangement is configured to store the one or more images and a set of instructions; and
a first data processing arrangement coupled to the imaging arrangement and the database arrangement, wherein the first data processing arrangement is configured to:
receive the trash in one or more sub-chambers inside the at least one container, at a first location;
move the at least one container from the first location to a second location, wherein the second location is a trash storage site, based on the one or more images of the environment captured by the imaging arrangement and the set of instructions stored in the database arrangement;
transfer the trash from the at least one container to the trash storage site; and
move the at least one container from the second location to the first location, based on the one or more images of the environment captured by the imaging arrangement and the set of instructions stored in the database arrangement.

2. A system according to claim 1, wherein the system further comprises a user device coupled to the first data processing arrangement wherein the user device is operable to provide the set of instructions to the first data processing arrangement.

3. A system according to claim 1 or 2, wherein the system further comprises a navigation module to enable the user device to track the at least one container.

4. The system according to any of the preceding claims, wherein the first data processing arrangement is implemented by a machine learning based circuitry.

5. The system according to any of the preceding claims, wherein the machine learning based circuitry is trained based on the set of instructions provided by the user device.

6. The system according to any of the preceding claims, wherein the system further comprises a first set of motor arrangement to move the at least one container.

7. The system according to any of the preceding claims, wherein the system further comprises a second set of motor arrangement to transfer the trash from the at least one container.

8. The system according to any of the preceding claims, wherein the system further comprises a sensory circuitry to sense a level of trash inside the at least one container.

9. The system according to any of the preceding claims, wherein the system further comprises an autonomous device coupled to the at least one container to enable movement of the at least one container from the first location to the second location and from the second location to the first location.

10. The system of claim 9, wherein the autonomous device is coupled to a first container of the at least one container by placing the first container on the autonomous device and/or is coupled at most two containers via a connecting rod.

11. The system of claim 10, wherein the connecting rod comprises one or more gripping arrangements to enable coupling of autonomous device to the at most two containers.

12. The system of claim 9, wherein the autonomous device further comprises a second data processing arrangement coupled to the first data processing arrangement to enable controlling the movement of the at least one container.

13. A method implemented by a trash management system comprising an at least one container, the at least one container when in operation is operable to manage trash, the method comprises:
capturing one or more images of an environment of the at least one container;
receiving the trash inside the at least one container, at a first location;
moving the at least one container from the first location to a second location, wherein the second location is a trash storage site, based on the one or more images of the environment and a set of instructions;
transferring the trash from the at least one container to the trash storage site; and
moving the at least one container from the second location to the first location, based on the one or more images of the environment and the set of instructions.

14. A method according to claim 13, wherein the method further comprises receiving the set of instructions from a user device.

15. The method according to claim 13 or 14, wherein the method is implemented by a machine learning based circuitry.

16. The method according to claims 13-15, wherein the machine learning based circuitry is trained based on the set of instructions provided by the user device.

17. The method according to claims 13-16, wherein the method further comprises sensing a level of trash inside the at least one container.
